(19) United States
(12) Patent Application Publication
(10) Pub. No.: US 2012/0173668 A1
(43) Pub. Date: Jul. 5, 2012

(54) CONTENT TRANSMITTING APPARATUS, CONTENT RECEIVING APPARATUS, CONTENT TRANSMISSION PROGRAM, CONTENT RECEPTION PROGRAM, CONTENT TRANSMITTING METHOD, AND CONTENT RECEIVING METHOD

(76) Inventor: Shinsuke Ogata, Osaka (JP)

(21) Appl. No.: 13/392,204

(22) PCT Filed: Apr. 16, 2010
(86) PCT No.: PCT/JP2010/002789

§ 371 Date: Feb. 24, 2012

(30) Foreign Application Priority Data
Sep. 11, 2009 (JP) 2009-210804

(51) Int. Cl. G06F 15/16

(52) U.S. Cl. 709/217

(57) ABSTRACT

Provided is a transmitting apparatus, a receiving apparatus, and the like that can switch a content even if the reception conditions of a plurality of streams are deteriorated at the same time, and that have reduced power consumption and an increased packet loss tolerance.

The receiving apparatus includes: a first reception section for receiving a first stream by predetermined unit and extracting first content data; a control section for determining whether or not the first stream has been normally received, with respect to each predetermined unit, and for, if the first stream has not been normally received, issuing an instruction to start reception of a second stream to be transmitted later than the first stream; a second reception section for, when the second reception section has received the instruction, starting reception of the second stream, receiving the second stream corresponding to the predetermined unit of the first stream that has not been received, and extracting second content data; and a reproduction control section for, if the first stream has not been received, reproducing a content for alternative display based on the second content data, and for, if the first stream has been received, reproducing a content for normal display based on the first content data at the same timing as a timing to reproduce the content for alternative display.

### TECHNICAL FIELD

The present invention relates to a system for transmitting and receiving a content, and more particularly, to a technique for increasing packet loss tolerance.

### BACKGROUND ART

In recent years, digital TVs that can receive digital terrestrial broadcasts have been rapidly spreading partly because analog terrestrial broadcasting will be finished.

In principle, the transmission method of the digital terrestrial broadcasting hardly causes the deterioration in signals. Therefore, basically, high definition videos can be reproduced irrespective of the reception environment. However, if the reception condition is partially deteriorated owing to electromagnetic interference or the like during transmission, in the digital method, packet loss occurs, whereby a part of the screen is not displayed or blackout occurs during a few seconds, though in the analog method, usually, noise just occurs in videos. Therefore, various ideas for increasing packet loss tolerance have been proposed.

One of conventional content receiving apparatuses having an increased packet loss tolerance is disclosed in Patent Literature 1. The content receiving apparatus includes a plurality of tuners for digital terrestrial broadcasting. The tuners concurrently receive respective broadcasts belonging to the same group and having different frequencies, and execute processing of generating respective pieces of video data. When video data generated based on the broadcast received by one of the tuners is displayed, if the video data has failed to be generated because the broadcast has failed to be received, the display is seamlessly and smoothly switched to the video data generated based on the broadcast received by another one of the tuners.

### CITATION LIST

### Patent Literature

[PTL 1] Japanese Laid-Open Patent Publication No. 2006-166035

### SUMMARY OF THE INVENTION

### Problems to be Solved by the Invention

However, for example, in the case where the reception condition of one of the tuners is deteriorated owing to severe electromagnetic interference caused by thunder or the like, it is considered that the reception conditions of the other tuners will be deteriorated at the same time. In the case where the broadcasting station is switched during travelling of a receiving apparatus of a vehicle or the degree of electromagnetic interference is relatively small, the digital broadcast receiving apparatus disclosed in Patent Literature 1 might be able to seamlessly and smoothly switch video data. However, in the case where the degree of electromagnetic interference is relatively large, since the other tuners fail in the reception at the same time as the first tuner, the video data cannot be switched.

In addition, in the configuration disclosed in Patent Literature 1, whether or not packet loss occurs, a plurality of tuners always need to continuously operate in parallel, and continuously execute processing of generating respective pieces of video data, so that the video data can be seamlessly and smoothly switched no matter when the video data fails to be generated. Therefore, there is a problem that power consumption increases.

Therefore, an object of the present invention is to provide a content transmitting apparatus, a content receiving apparatus, a content transmission program, a content reception program, a content transmitting method, and a content receiving method that are capable of: firstly, switching display to a content for alternative display even if the reception conditions of a plurality of streams are deteriorated at the same time; and secondly, reducing the power consumption and increasing the packet loss tolerance, without always continuously operating a plurality of tuners in parallel or always continuously executing a plurality of processings of generating contents such as video data in parallel as in Patent Literature 1.

### Solution to the Problems

The present invention is directed to a content transmitting apparatus, a content receiving apparatus, a content transmission program, a content reception program, a content transmitting method, and a content receiving method. In order to solve the above problems, a content receiving apparatus according to the present invention is a content receiving apparatus which receives a stream transmitted from a transmitting apparatus, extracts content data from the stream, and reproduces a content, the content receiving apparatus including: a first reception section configured to execute processing of sequentially receiving a first stream by predetermined unit, and extract first content data from the predetermined unit of the first stream that has been received; a recovery control section configured to determine whether or not the first stream has been normally received by the first reception section, with respect to each predetermined unit, and to, if the recovery control section has determined that the first stream has not been normally received, issue an instruction to start reception of a second stream for alternative display which is transmitted from the transmitting apparatus later than the first stream; a second reception section configured to, when the second reception section has received the instruction from the recovery control section, start reception of the second stream, receive a predetermined unit of the second stream corresponding to the predetermined unit of the first stream that the recovery stream control section has determined to have not been normally received, and extract second content data from the predetermined unit of the second stream that has been received; and a reproduction control section configured to, if the recovery stream section has determined that the first stream has not been normally received, reproduce a content for alternative display, based on the second content data extracted from the predetermined unit of the second stream that has been received by the second reception section, and if the recovery stream section has determined that the first stream has been normally received, reproduce a content for normal display, at the same timing as a timing to reproduce the content for alternative display, based on the first content data extracted from the predetermined unit of the first stream that has been received by the first reception section.

Preferably, if the recovery control section has determined that the predetermined unit of the first stream has been normally received, the recovery control section may not supply power to constituent sections for executing processing of receiving the second stream, and constituent sections for executing processing of extracting the second content data.

Preferably, if the recovery control section has determined that the predetermined unit of the first stream has not been normally received, the recovery control section may not supply power to constituent sections for executing processing of receiving the first stream, and constituent sections for executing processing of extracting the first content data, until the processing of receiving the first stream becomes able to be restarted.

Preferably, if the recovery control section has determined that the predetermined unit of the first stream has not been normally received, and if content data of a reference image is needed in order to reproduce a content for alternative display corresponding to a content to be reproduced based on the predetermined unit of the first stream, the recovery control section may start reception of a predetermined unit of the second stream from a position that includes the content data of the reference image that are needed. Preferably, the second stream may have a higher transmission tolerance than the first stream.

In order to solve the above problems, a content transmitting apparatus according to the present invention is a content transmitting apparatus which transmits, to a content receiving apparatus, a stream that includes content data used for reproducing a content, the content transmitting apparatus including: a stream generation section configured to generate a first stream that includes first content data, and a second stream for alternative display that includes second content data used for reproducing a content for alternative display whose representation object is substantially the same as that of a content for normal display to be reproduced based on the first content data; and a transmission section configured to transmit the first stream, and transmitting the second stream later than the first stream, so that, when a predetermined unit of the first stream has not been normally received by the content receiving apparatus, even if the content receiving apparatus starts reception of the second stream after it is determined that the predetermined unit of the first stream has not been normally received, the content receiving apparatus can receive the second stream corresponding to the predetermined unit of the first stream that has not been normally received.

Preferably, the stream generation section may include: a first generation section configured to generate the first stream; a second generation section configured to generate the second stream; and a transmission delay time storage section configured to store, in advance, transmission delay time information indicating the interval of redundant data to be transmitted before data of the second stream is transmitted. The transmission section may include: a first transmission section configured to transmit the first stream; and a second transmission section configured to transmit the second stream. The second generation section may send, to the second transmission section, redundant data having the interval indicated by the transmission delay time information stored in the transmission delay time storage section, thereby causing the second stream to wait to be transmitted, and may send the second stream to the second transmission section after the waiting, so that the second stream is transmitted later than the first stream.

Preferably, the first generation section may further generate return reception time information specifying a time until which reception of the first stream can be interrupted when packet loss has occurred, such that the return reception time information is associated with each packet. The second generation section may further generate reception time information specifying a time to start reception of the second stream when packet loss has occurred, such that the reception time information is associated with each packet. The first transmission section may transmit the return reception time information generated by the first generation section and the reception time information generated by the second generation section, together with the first stream. Preferably, the second generation section may generate the second stream having a higher transmission tolerance than that of the first stream generated by the first generation section.

In order to solve the above problems, a content receiving program according to the present invention is a content reception program executed by a content receiving apparatus which receives a stream transmitted from a transmitting apparatus, extracts content data from the stream, and reproduces a content, the content reception program causing the content receiving apparatus to execute: a first reception step of executing processing of sequentially receiving a first stream by predetermined unit, and extracting first content data from the predetermined unit of the first stream that has been received; a recovery control step of determining whether or not the first stream has been normally received in the first reception step, with respect to each predetermined unit, and of, if the recovery control step has determined that the first stream has not been normally received, issuing an instruction to start reception of a second stream for alternative display which is transmitted from the transmitting apparatus later than the first stream; a second reception step of, when the instruction has been issued in the recovery control step, starting reception of the second stream, receiving a predetermined unit of the second stream corresponding to the predetermined unit of the first stream that the recovery stream control step has determined to have not been normally received, and extracting second content data from the predetermined unit of the second stream that has been received; and a reproduction control step of, if the recovery stream step has determined that the first stream has not been normally received, reproducing a content for alternative display, based on the second content data extracted from the predetermined unit of the second stream that has been received in the second reception step, and if the recovery stream step has determined that the first stream has been normally received, reproducing a content for normal display, at the same timing as a timing to reproduce the content for alternative display, based on the first content data extracted from the predetermined unit of the first stream that has been received in the first reception step.

In order to solve the above problems, a content transmitting program according to the present invention is a content reception program executed by a content transmitting apparatus which transmits, to a content receiving apparatus, a stream that includes content data used for reproducing a content, the content reception program causing the content transmitting apparatus to execute: a stream generation step of generating a first stream that includes first content data, and a second stream for alternative display that includes second content data used for reproducing a content for alternative display whose representation object is substantially the same as that of a content for normal display to be reproduced based on the first content data; and a transmission step of transmitting the first stream, and transmitting the second stream later than the first stream, so that, when a predetermined unit of the first stream has not been normally received by the content receiving apparatus, even if the content receiving apparatus starts reception of the second stream after it is determined that the predetermined unit of the first stream has not been normally received, the content receiving apparatus can receive the second stream corresponding to the predetermined unit of the first stream that has not been normally received.

In order to solve the above problems, a content receiving method according to the present invention is a content receiving method in which a stream transmitted from a transmitting apparatus is received, content data is extracted from the stream, and a content is reproduced, the content receiving method including: a first reception step of executing processing of sequentially receiving a first stream by predetermined unit, and extracting first content data from the predetermined unit of the first stream that has been received; a recovery control step of determining whether or not the first stream has been normally received in the first reception step, with respect to each predetermined unit, and of, if the recovery control step has determined that the first stream has not been normally received, issuing an instruction to start reception of a second stream for alternative display which is transmitted from the transmitting apparatus later than the first stream; a second reception step of, when the instruction has been issued in the recovery control step, starting reception of the second stream, receiving a predetermined unit of the second stream corresponding to the predetermined unit of the first stream that the recovery stream control step has determined to have not been normally received, and extracting second content data from the predetermined unit of the second stream that has been received; and a reproduction control step of, if the recovery stream step has determined that the first stream has not been normally received, reproducing a content for alternative display, based on the second content data extracted from the predetermined unit of the second stream that has been received in the second reception step, and if the recovery stream step has determined that the first stream has been normally received, reproducing a content for normal display, at the same timing as a timing to reproduce the content for alternative display, based on the first content data extracted from the predetermined unit of the first stream that has been received in the first reception step.

In order to solve the above problems, a content transmitting method according to the present invention is a content transmitting method in which a stream that includes content data used for reproducing a content is transmitted to a content receiving apparatus, the content transmitting method including: a stream generation step of generating a first stream that includes first content data, and a second stream for alternative display that includes second content data used for reproducing a content for alternative display whose representation object is substantially the same as that of a content for normal display to be reproduced based on the first content data; and a transmission step of transmitting the first stream, and transmitting the second stream later than the first stream, so that, when a predetermined unit of the first stream has not been normally received by the content receiving apparatus, even if the content receiving apparatus starts reception of the second stream after it is determined that the predetermined unit of the first stream has not been normally received, the content receiving apparatus can receive the second stream corresponding to the predetermined unit of the first stream that has not been normally received.

### ADVANTAGEOUS EFFECTS OF THE INVENTION

As described above, according to the present invention, the content transmitting apparatus generates and broadcasts the first stream that includes the first content data, and broadcasts the second stream for alternative display that includes the second content data later than the first stream. When the content receiving apparatus is successfully receiving the first stream and normally extracting the first content data, processing of receiving the second stream and processing of reproducing a content based on the second stream are not performed. Only when the content receiving apparatus cannot normally extract the first content data, reception of the second stream is started. Then, the second content data corresponding to the first content data that cannot be normally extracted is extracted, and a content based on the second content data is reproduced. By using the above configuration, it becomes possible to switch display to a content for alternative display even if the reception conditions of both the first stream for normal display and the second stream for alternative display are deteriorated at the same time. In addition, when display does not need to be switched, it is not necessary to execute processing of receiving the second stream or processing of generating a content based on the second stream. Therefore, the present invention can greatly reduce the power consumption in comparison with an apparatus in which two tuners always continuously operate in parallel and processing of generating a plurality of contents is continuously executed.

In addition, during recovering, processing of receiving the first stream and processing of generating a content based on the first stream are stopped until extraction of the first content data becomes able to be restarted. Thus, the power consumption can be further reduced.

In addition, the transmission tolerance of the second stream is set to be higher than that of the first stream. Therefore, it is expected that, even in such a severe reception environment that reception of the first stream frequently fails, a part of the screen is efficiently prevented from not being displayed, or the whole screen is efficiently prevented from being blacked out.

### BRIEF DESCRIPTION OF THE DRAWINGS

FIG. 1 is a schematic diagram showing the configuration of content transmission/reception system 10 according to the present invention.

FIG. 2 is a schematic diagram showing the details of a main stream generation section 104 and a recovery stream generation section 108.

FIG. 3 shows an example of the configuration of return reception time information.

FIG. 4 shows an example of the configuration of recovery reception time information.

FIG. 5 shows the details of the configuration of a recovery control section 204.

FIG. 6 is a schematic diagram showing timings of transmission, reception, and reproduction.

FIG. 7 is another schematic diagram showing timings of transmission, reception, and reproduction.

FIG. 8 shows a process of the operation of transmitting a main stream by a content transmitting apparatus 100.

FIG. 9 shows a process of the operation of transmitting a recovery stream by the content transmitting apparatus 100.

FIG. 10 shows a process of power control operation by a content receiving apparatus 200.

FIG. 11 shows a process of the operation of receiving a main stream by the content receiving apparatus 200.

FIG. 12 shows a process of the operation of receiving a recovery stream by the content receiving apparatus 200.

### DESCRIPTION OF EMBODIMENTS

### First Embodiment

### <Summary>

The present embodiment is directed to a system for transmitting and receiving a content. In the system, the transmission side transmits a main stream which is a main reception object, and transmits a recovery stream for alternative display later than the main stream. The reception side extracts content data for normal display from the main stream, and reproduces a content. At this time, if it has been determined that the extraction of a predetermined unit of the content data has failed, the reception side starts to receive the recovery stream which is broadcasted later than the main stream. The reception side extracts content data for alternative display that corresponds to the content data for normal display which has failed to be extracted, and reproduces a content. As a result, even if the reception conditions of a plurality of streams are deteriorated at the same time, it becomes possible to switch the content for normal display to the content for alternative display which includes substantially the same presentation object as the content for normal display. In addition, if the content data for normal display is normally extracted from the main stream, the reception side does not perform processing of receiving the recovery stream so that the power consumption will be reduced. In addition, if the content data for normal display is not normally extracted from the main stream, the reception side does not perform processing of receiving the main stream, until the extraction of content data for normal display becomes able to be restarted, so that the power consumption will be further reduced.

### <Configuration>

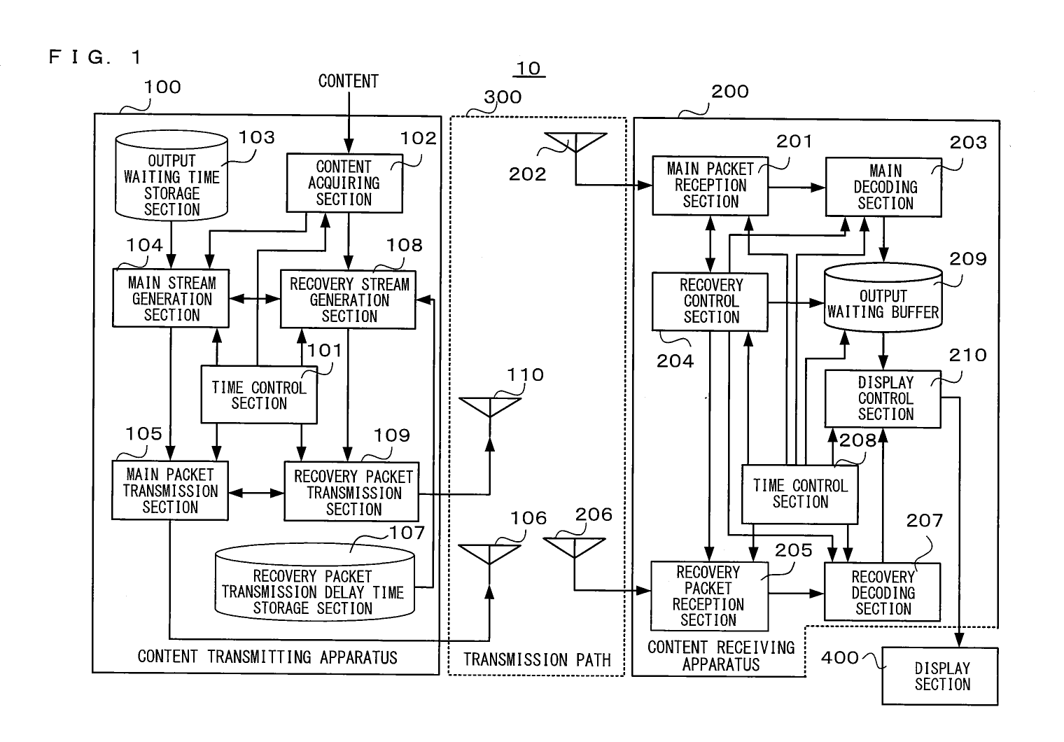

FIG. 1 shows the schematic configuration of a content transmission/reception system 10 according to the present invention.

As shown in FIG. 1, the content transmission/reception system 10 includes a content transmitting apparatus 100, a content receiving apparatus 200, a transmission path 300, and a display section 400. The content receiving apparatus 200 receives, via the transmission path 300, a stream broadcasted by the content transmitting apparatus 100. The content receiving apparatus 200 extracts content data from the stream to reproduce a content, and causes the display section 400 to display the content.

The content transmitting apparatus 100 includes a time control section 101, a content acquiring section 102, an output waiting time storage section 103, a main stream generation section 104, a main packet transmission section 105, a main transmission antenna 106, a recovery packet transmission delay time storage section 107, a recovery stream generation section 108, a recovery packet transmission section 109, and a recovery transmission antenna 110. The content transmitting apparatus 100 generates content data for normal display processed by MPEG-2 encoding, and content data for alternative display processed by H.264 encoding. After the two kinds of encoded content data are generated, the content transmitting apparatus 100 transmits a main stream including the content data for normal display, and transmits a recovery stream including the content data for alternative display later than the main stream.

The content receiving apparatus 200 includes a main packet reception section 201, a main antenna 202, a main decoding section 203, a recovery control section 204, a recovery packet reception section 205, a recovery antenna 206, a recovery decoding section 207, a time control section 208, an output waiting buffer 209, and a display control section 210. The content receiving apparatus 200 receives a main stream and a recovery stream transmitted from the content transmitting apparatus 100, extracts content data from the main stream and the recovery stream, and reproduces and outputs the content.

The transmission path 300 is a space for propagating a radio wave for transmitting a stream broadcasted from the content transmitting apparatus 100 to the content receiving apparatus 200, or a transmission medium such as an optical cable.

The time control section 101 controls and manages the current time in the content transmitting apparatus 100. The managed time is used as a reference time for determining the operation timings of the constituent sections.

The content acquiring section 102 generates content data such as video data by shooting a video, or acquires content data itself to be transmitted, from the outside. When the content acquiring section 102 shoots a video in real time or sequentially acquires video data in real time, the content acquiring section 102 allocates a PTS (Presentation Time Stamp) to each frame of the acquired video data. The allocated PTS has a value obtained by adding an output delay value to the current time managed by the time control section 101. In this way, if a value calculated based on the current time in the content transmitting apparatus 100 managed by the time control section 101 is allocated as a PTS to each piece of picture data, the content receiving apparatus 200 refers to the PTSs, thereby outputting a continuous video in accordance with the correct order of acquired video data.

The above output delay value is defined as “(a maximum estimated value of a delay time from when the content transmitting apparatus 100 acquires content data until the content receiving apparatus 200 displays a video)+(a value stored in the output waiting time storage section 103)”.

The above “maximum estimated value of a delay time from when the content transmitting apparatus 100 acquires content data until the content receiving apparatus 200 displays a video” is the sum of times taken in encoding processing, multiplexing processing, radio transmission processing, demultiplexing processing, decoding processing, and the like.

The output waiting time storage section 103 stores, in advance, reproduction waiting time information indicating a time during which the content receiving apparatus 200 needs to wait for delaying reproduction of a main content, for example, a waiting time from when content data is acquired until a content is reproduced, so as to adjust a timing in the case where recovery is needed.

The main stream generation section 104 acquires content data from the content acquiring section 102, processes the content data by MPEG-2 encoding, and multiplexes the encoded content data in an MPEG2-TS, thereby generating a main stream.

The main packet transmission section 105 transmits the main stream generated by the main stream generation section 104, to the transmission path 300, by using the main transmission antenna 106.

The recovery packet transmission delay time storage section 107 stores, in advance, recovery transmission delay time information indicating the interval of redundant data transmitted before the transmission of data of a recovery stream so that the content transmitting apparatus 100 can transmit the recovery stream later than the main stream.

The recovery stream generation section 108 acquires content data from the content acquiring section 102, and processes the content data by H. 264 encoding, thereby generating a recovery stream.

The recovery packet transmission section 109 transmits the recovery stream generated by the recovery stream generation section 108, to the transmission path 300, by using the recovery transmission antenna 110.

Here, the recovery stream generation section 108 sends redundant data having the interval indicated by the recovery transmission delay time information stored in the recovery packet transmission delay time storage section 107, thereby causing the generated recovery stream to wait to be sent, and then sends the generated recovery stream to the recovery packet transmission section 109. In this way, the recovery stream generation section 108 delays the transmission of the recovery stream relative to the main stream.

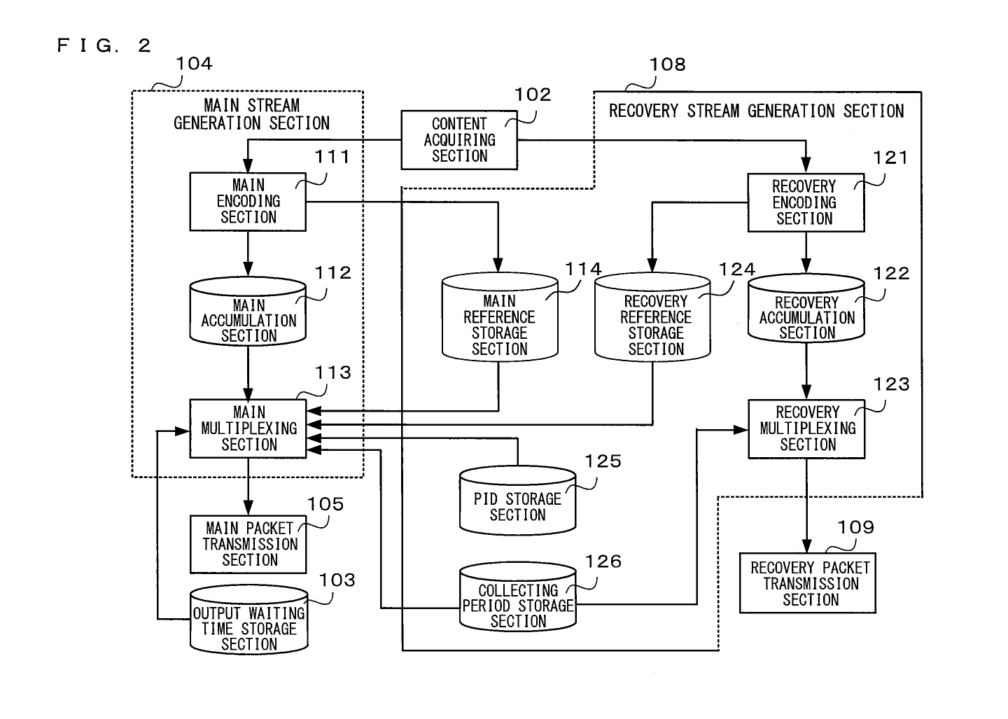

FIG. 2 is a schematic diagram showing the details of the main stream generation section 104 and the recovery stream generation section 108.

The main stream generation section 104 includes a main encoding section 111, a main accumulation section 112, a main multiplexing section 113, and a main reference storage section 114. The recovery stream generation section 108 includes a recovery encoding section 121, a recovery accumulation section 122, a recovery multiplexing section 123, a recovery reference storage section 124, a PID storage section 125, and a collecting period storage section 126.

The main encoding section 111 processes, by MPEG-2 encoding, content data acquired by the content acquiring section 102, and allocates a PTS to each frame of the resultant content data processed by MPEG-2 encoding. The main encoding section 111 sends all pieces of the content data to the main accumulation section 112, and the main accumulation section 112 stores them. In addition, the main encoding section 111 sends the PTS of a reference frame included in the content data processed by MPEG-2 encoding, to the main reference storage section 114, and the main reference storage section 114 stores the PTS. In the present embodiment, a PTS indicating an actual time to reproduce a content is used for specifying each frame. However, the present invention is not limited thereto. Any information may be used as long as each frame can be specified and the correspondence relationship between a main packet and a recovery packet can be recognized. For example, information indicating a relative time period from the time to reproduce the first frame to the time to reproduce each frame, may be used for specifying frames.

In addition, the main encoding section 111 acquires the PTS of the next reference frame with respect to each packet. Based on the PTS, the main encoding section 111 generates return reception time information indicating the timing for the content receiving apparatus 200 to restart reception of a main stream after interruption of the reception, such that the return reception time information is associated with each packet. The main encoding section 111 sends the return reception time information to the main reference storage section 114, and the main reference storage section 114 stores it. Here, “the time until which the reception of a main stream can be interrupted in the case where packet loss has occurred” can be specified from the return reception time information.

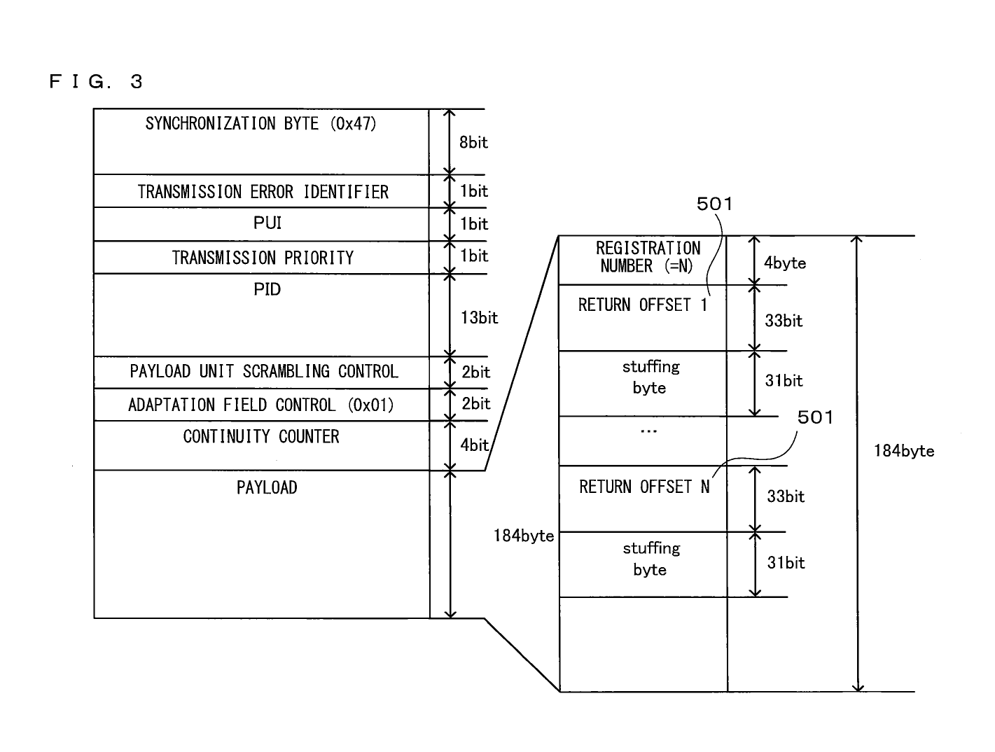

FIG. 3 shows an example of the configuration of the return reception time information.

In the return reception time information shown in FIG. 3, “a return offset 501 indicating the difference between the PTS of a piece of encoded data and the PTS of the next piece of encoded data” is associated with each frame.

Although in the present embodiment, the return reception time information has the configuration shown in FIG. 3, the return reception time information may have any configuration as long as the same effect is provided.

In the present embodiment, the PTS of a piece of encoded data is synchronized with the actual time to transmit the piece of encoded data. In addition, the actual time is synchronized with the internal time of the content receiving apparatus 200 described later. That is, the PTS of a piece of encoded data is synchronized with “the internal time of the content receiving apparatus 200”. Therefore, the “internal time of the content receiving apparatus 200” when the reference frame next to a reference frame will be received is calculated from a return offset included in the return reception time information, and the internal time of the content receiving apparatus 200. That is, in the case where one of the pieces of encoded data from a reference frame to the next reference frame has been lost, the “internal time of the content receiving apparatus 200” when the next reference frame with respect to the lost piece of data will be received can be acquired by referring to the return reception time information. That is, if the return reception time information is multiplexed just before a reference frame, it becomes possible to, when the content receiving apparatus 200 has failed to acquire a packet of the data processed by MPEG-2 encoding, receive the next reference frame while avoiding receiving unnecessary part of the data processed by MPEG-2 encoding included before the next reference frame.

In the present embodiment, the PTS of a piece of content data is synchronized with the actual transmission timing of the piece of the content data. This is merely an example for facilitating conversion from the PTS to the actual transmission timing. Therefore, instead of synchronizing the PTS of a piece of content data with the actual transmission timing of the piece of content data, the transmission timing of a piece of content data may be directly superimposed as a part of return reception time information and a part of recovery reception time information.

The main accumulation section 112 accumulates a main content processed through MPEG-2 encoding by the main encoding section 111.

The main multiplexing section 113 starts processing at regular intervals, in which the main multiplexing section 113 acquires content data processed by MPEG-2 encoding and accumulated in the main accumulation section 112, and multiplexes the content data in an MPEG2-TS as a main stream.

The main reference storage section 114 stores the return reception time information generated by the main encoding section 111. In addition, the main reference storage section 114 receives the PTS of a reference frame included in a main stream from the main encoding section 111, and accumulates the PTS.

The recovery encoding section 121 processes, by H. 264 encoding, the content data acquired by the content acquiring section 102, and sends all pieces of the content data processed by H. 264 encoding to the recovery accumulation section 122. The recovery accumulation section 122 accumulates the received content data. In addition, the recovery encoding section 121 sends the PTS of a reference frame included in the content data processed by H. 264 encoding to the recovery reference storage section 124. The recovery reference storage section 124 stores the received PTS.

In addition, the recovery encoding section 121 acquires the PTS of a reference frame in a recovery stream with respect to each packet. Based on the PTS, the recovery encoding section 121 generates recovery reception time information indicating the timing for the content receiving apparatus 200 to start reception of a recovery stream, such that the recovery reception time information is associated with each packet. The recovery encoding section 121 sends the recovery reception time information to the recovery reference storage section 124, and the recovery reference storage section 124 stores it. Here, “the time to start reception of a recovery stream in the case where packet loss has occurred” can be specified from the recovery reception time information.

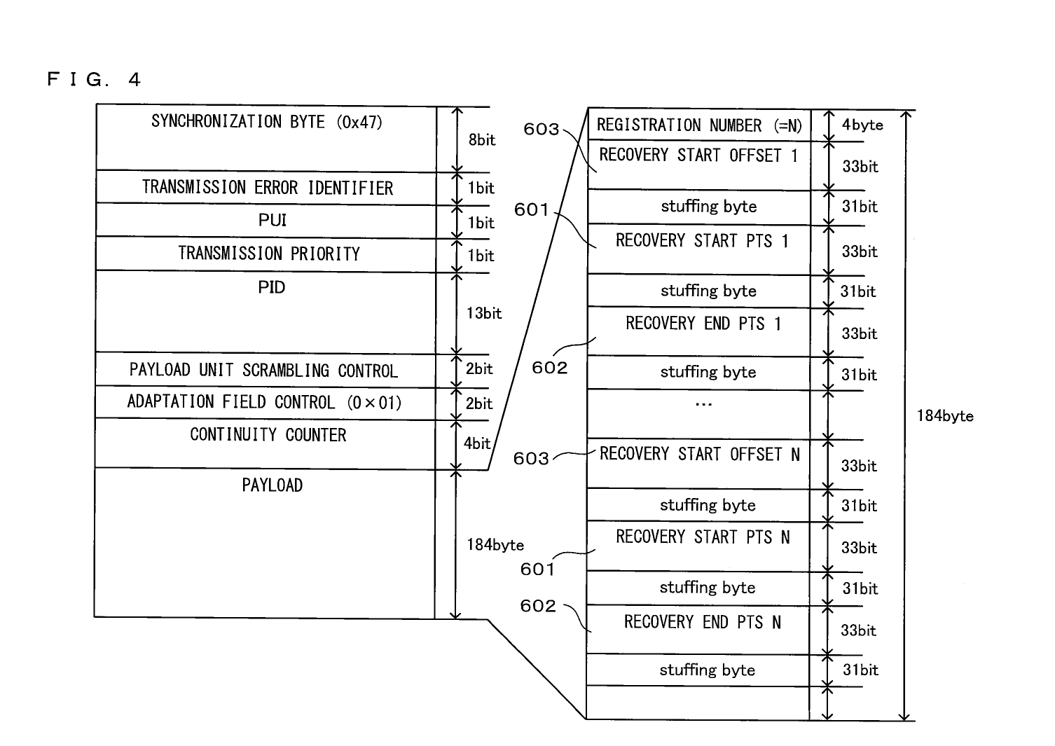

FIG. 4 shows an example of the configuration of the recovery reception time information.

As shown in FIG. 4, in the recovery reception time information, “the PTS of a specific reference frame in a recovery stream (recovery start PTS 601)”, “the PTS of the reference frame next to the specific reference frame (recovery end PTS 602)”, and “the time period from when the recovery reception time information is received to when reception of the specific reference frame in the recovery stream is started (recovery start offset 603)”, are associated with each frame.

Although in the present embodiment, the recovery reception time information has the configuration shown in FIG. 4, the recovery reception time information may have any configuration as long as the same effect is provided.

When the content receiving apparatus 200 has acquired recovery reception time information, the content receiving apparatus 200 calculates a recovery reception start time to start reception of a reference frame, from the internal time of the content receiving apparatus 200, and the recovery start offset. When a piece of data having a PTS between a recovery start PTS and a recovery end PTS has been lost, the content receiving apparatus 200 can acquire alternative data for the lost piece of data by receiving a specific reference frame from a recovery stream. That is, in the case where, in a main stream, a piece of data having a PTS between a recovery start PTS and a recovery end PTS has been lost, the content receiving apparatus 200 starts reception of a recovery stream from the recovery reception start time, thereby receiving a specific reference frame and acquiring alternative data for the lost piece of data from the recovery stream.

The recovery accumulation section 122 accumulates content data processed through H. 264 encoding by the recovery encoding section 121.

The recovery multiplexing section 123 starts processing at regular intervals, in which the recovery multiplexing section 123 acquires the content data processed by H. 264 encoding and accumulated in the recovery accumulation section 122, and multiplexes the content data as a recovery stream.

The recovery reference storage section 124 stores the recovery reception time information generated by the recovery encoding section 121. In addition, the recovery reference storage section 124 receives the PTS of a reference frame in a recovery stream from the recovery encoding section 121, and accumulates the PTS.

The PID storage section 125 stores in advance a main return PID value for identifying the return reception time information (PID is an abbreviation of Packet ID, and means a packet identifier), and a recovery PID value for identifying the recovery reception time information.

The collecting period storage section 126 stores, in advance, reference FR information collecting period indicating the range of PTSs of encoded content data to be accumulated in a buffer in order to accumulate the PTSs of reference frames in a main stream within a predetermined interval, and the PTSs of reference frames in a recovery stream within a predetermined interval.

Further, the main multiplexing section 113 outputs the PTSs of reference frames of a main stream stored in the main reference storage section 114, the return reception time information stored in the main reference storage section 114, the PTSs of reference frames of a recovery stream stored in the recovery reference storage section 124, and the recovery reception time information stored in the recovery reference storage section 124. These pieces of information are outputted being included in a main stream, as some internal parameters of the content transmitting apparatus.

Here, when the return reception time information is multiplexed in an MPEG2-TS, the main return PID value stored in the PID storage section 125 is acquired and set as the PID of the MPEG2-TS. In addition, when the recovery reception time information is multiplexed in an MPEG2-TS, the recovery PID value stored in the PID storage section 125 is acquired and set as the PID of the MPEG2-TS.

The main packet reception section 201 receives packets in a main stream at regular intervals by using the main antenna 202, and extracts content data from the received packet of the main stream. Here, if PCR information (Program Clock Reference) is included in the received packet in the main stream, the main packet reception section 201 extracts the PCR information, and sends it to the time control section 208. If content data processed by MPEG-2 encoding is included in the received packet of the main stream, the main packet reception section 201 extracts the content data and sends it to the main decoding section 203. If return reception time information indicating the reception timing of the main stream is included in the received packet of the main stream, the main packet reception section 201 extracts the return reception time information and converts it into actual return reception time information corresponding to the time axis of the content receiving apparatus 200. The main packet reception section 201 sends the actual return reception time information to a main power control section 215 of the recovery control section 204. If recovery reception time information indicating the reception timing of a recovery stream is included in the received packet of the main stream, the main packet reception section 201 extracts the recovery reception time information, and converts it into actual recovery reception time information corresponding to the time axis of the content receiving apparatus 200. The main packet reception section 201 outputs the actual recovery reception time information to a recovery power control section 212 of the recovery control section 204.

The main antenna 202 receives a main stream transmitted to the transmission path 300 by the main transmission antenna 106.

The main decoding section 203 receives the data processed by MPEG-2 encoding included in the main stream, from the main packet reception section 201, and sequentially processes the data by MPEG-2 decoding by predetermined unit, thereby generating content data for normal display. The content data is accumulated in the output waiting buffer 209 once, whereby the display timing is delayed. Then, the content data is sent to the display control section 210.

The recovery control section 204 determines, for every predetermined unit, whether or not the main packet reception section 201 can receive the predetermined unit of the main stream. In the present embodiment, the recovery control section 204 determines whether or not a packet in the main stream can be normally received. If the recovery control section 204 has determined that the predetermined unit of the main stream cannot be normally received, the recovery control section 204 determines the reception timing of the predetermined unit of a recovery stream corresponding to the predetermined unit of the main stream, based on the multiplexed information included in the main stream. Only at the reception timing, the recovery control section 204 supplies power to constituent sections relating to reception and reproduction of the recovery stream, thereby starting the reception of the recovery stream.

The recovery packet reception section 205 receives a recovery stream by using the recovery antenna 206, extracts the data processed by H. 264 encoding from the received recovery stream, and sends the extracted data to the recovery decoding section 207.

The recovery antenna 206 receives a recovery stream transmitted to the transmission path 300 by the recovery transmission antenna 110.

The recovery decoding section 207 receives the data processed by H. 264 encoding included in the recovery stream, from the recovery packet reception section 205, and sequentially processes the data by H. 264 decoding by predetermined unit, thereby generating content data for alternative display. The recovery decoding section 207 sends the content data to the display control section 210.

The time control section 208 controls and manages the current time in the content receiving apparatus 200. The managed time is used as a reference time for determining the operation timings of the constituent sections. In addition, when PCR information is acquired, the time control section 208 controls the value of the current time and the velocity of progression of the current time.

The output waiting buffer 209 stores a content reproduced by the main decoding section 203 once before the content is displayed. The content is retained, from when the content is acquired, during a waiting time indicated by reproduction waiting time information stored in the output waiting time storage section 103, and then is outputted, so that the display timing is delayed.

The display control section 210 temporarily accumulates the content for normal display which has been accumulated in the output waiting buffer 209 once and outputted after a predetermined time period, and the content for alternative display which has been reproduced by the recovery decoding section 207. Then, at the time indicated by the PTS of the content data, the display control section 210 reproduces the content and causes the display section 400 to display it. Here, the display control section 210 preferentially reproduces the content for normal display relative to the content for alternative display.

The display section 400 is an output apparatus for audio and video such as a video monitor and a speaker.

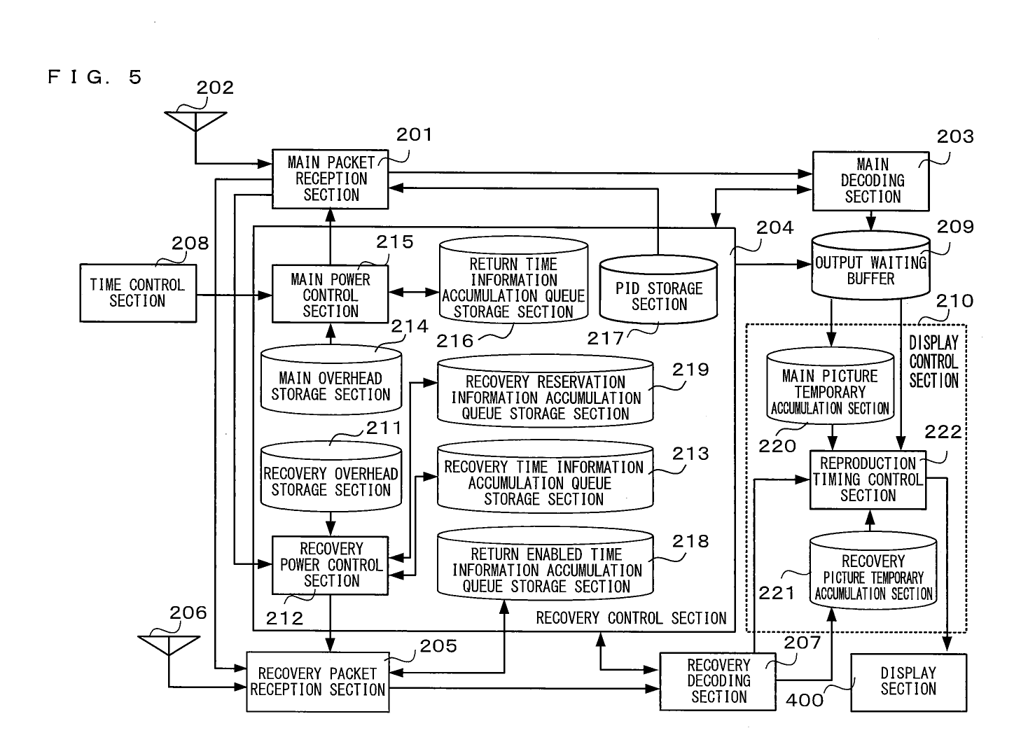

FIG. 5 shows the details of the configurations of the recovery control section 204 and the display control section 210.

The recovery control section 204 includes a recovery overhead storage section 211, the recovery power control section 212, a recovery time information accumulation queue storage section 213, a main overhead storage section 214, the main power control section 215, a return time information accumulation queue storage section 216, a PID storage section 217, a return enabled time information accumulation queue storage section 218, and a recovery reservation information accumulation queue storage section 219.

The display control section 210 includes a main picture temporary accumulation section 220, a recovery picture temporary accumulation section 221, and a reproduction timing control section.

The recovery overhead storage section 211 stores in advance a recovery overhead value indicating a time taken from when reception of a recovery stream is started until the recovery stream actually becomes able to be received.

The recovery power control section 212 receives the actual recovery reception time information from the main packet reception section 201, and based on the actual recovery reception time information, determines whether or not to supply power needed for receiving a recovery stream to the recovery packet reception section 205, thereby switching the supply of power. Here, when the supply of power to the recovery packet reception section 205 is switched, supply of power to the recovery decoding section 207 may be switched after processing for previously received data is completed, whereby both power to the respective constituent sections relating to the reception and power to the reproduction of a recovery stream may be controlled.

The recovery time information accumulation queue storage section 213 stores the actual recovery reception time information sent from the main packet reception section 201.

The main overhead storage section 214 stores in advance a main overhead value indicating a time taken from when reception of a main stream is started until the main stream actually becomes able to be received.

The main power control section 215 receives the actual recovery reception time information from the main packet reception section 201, and based on the actual recovery reception time information, determines whether or not to supply power needed for receiving a recovery stream to the main packet reception section 201, thereby switching the supply of power. Here, when the supply of power to the main packet reception section 201 is switched, supply of power to the main decoding section 203 may be switched after processing for previously received data is completed, whereby both power to the respective constituent sections relating to the reception and power to the reproduction of a main stream may be controlled.

The return time information accumulation queue storage section 216 stores the actual return reception time information sent from the main packet reception section 201.

The PID storage section 217 stores the recovery PID value for identifying the recovery reception time information, and the main return PID value for identifying the return reception time information.

The return enabled time information accumulation queue storage section 218 acquires the PTS of a reference frame from the recovery packet reception section 205, and stores the PTS.

The recovery reservation information accumulation queue storage section 219 acquires the PTS of a piece of content data in a main stream acquired just before reception of the main stream has failed.

The main picture temporary accumulation section 220 temporarily accumulates a piece of content data for normal display until the reproduction timing control section 222 reproduces the piece of content data at the time to display it, the timing of displaying the piece of content data having been delayed by the output waiting buffer 209 storing the piece of content data once and outputting it a predetermined time period later. Instead of the output waiting buffer 209 and the main picture temporary accumulation section 220, one storage section having their functions may be provided.

The recovery picture temporary accumulation section 221 temporarily stores a piece of content data for alternative display generated by the recovery decoding section 207, until the reproduction timing control section 222 reproduces the piece of content data at the time to display it, or until the piece of content data becomes unnecessary because, for example, a piece of content data for normal display to be reproduced at said time is accumulated in the main picture temporary accumulation section 220.

At the time indicated by the PTS of each piece of the content data, the reproduction timing control section 222 reproduces the content for normal display temporarily accumulated in the main picture temporary accumulation section 220, and the content for alternative display temporarily accumulated in the recovery picture temporary accumulation section 221, such that the content for normal display is preferentially reproduced, and causes the display section 400 to display the content.

Although in the present embodiment, the encoding method of the main encoding section 111 is MPEG 2, and the encoding method of the recovery encoding section 121 is H. 264, another encoding method may be used. In addition, the same encoding method may be applied to the main encoding section 111 and the recovery encoding section 121.

As in the present embodiment, if the redundancy of the transmission signal is increased such that the bit rate in encoding of the recovery encoding section 121 is set to be smaller than the bit rate in encoding of the main encoding section 111, the transmission error tolerance of a stream for alternative display can be increased. Therefore, even if a piece of content data in a main stream to be received by the content receiving apparatus 200 is lost, an alternative piece of data for the lost piece of data is likely to be acquired from a recovery stream, and a continuous video is likely to be provided. Thus, the recovering ability can be increased.

In addition, as a transmission method, a QPSK (quadrature phase shift keying, which has a high transmission tolerance), a 16QAM (16 quadrature amplitude modulation, which has a middle transmission tolerance), or 64QAM (64 quadrature amplitude modulation, which has a low transmission tolerance) is used, for example. Besides the selection of the redundancy bit, if the transmission tolerance of the transmission method for a recovery stream is set to be higher than that of the transmission method for a main stream, the recovery ability can be increased as described above.

### <Operation Timings of Transmission, Reception, and Reproduction>

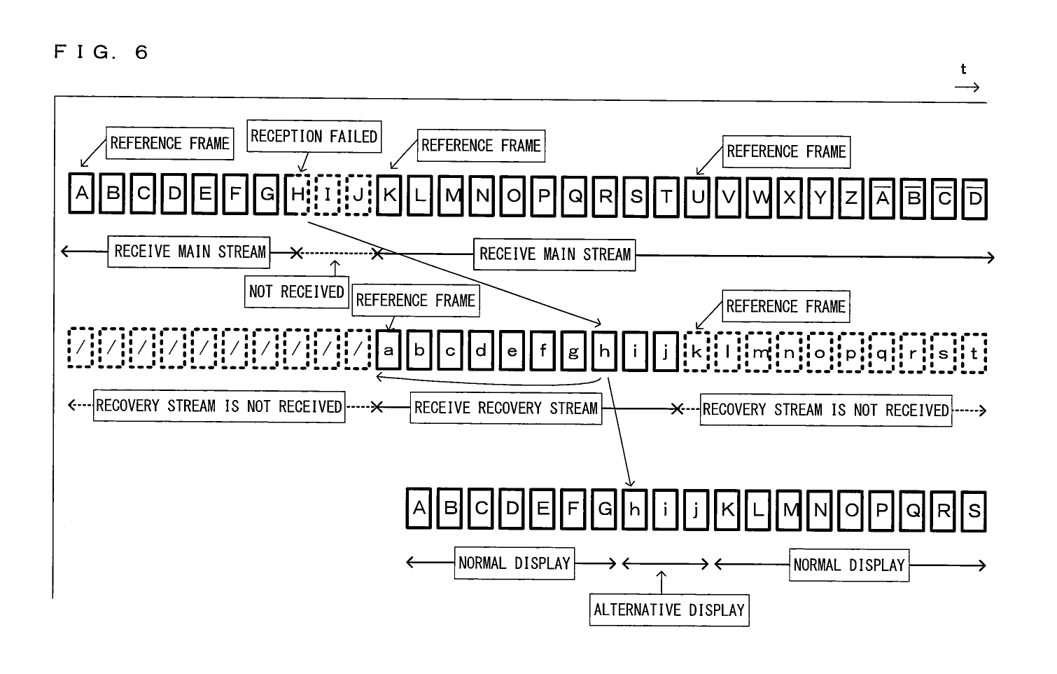

FIG. 6 is a schematic diagram showing the timings of transmission, reception, and reproduction.

With reference to FIG. 6, the timings of transmission and reception of a main stream, the timings of transmission and reception of a recovery stream, and the timing of reproduction will be described.

In FIG. 6, the horizontal axis represents time, progressing from left to right. The uppermost row indicates the transmission timing of each packet in a main stream, and the second row indicates the transmission timing of each packet in a recovery stream. The capital alphabet signs are assigned to the respective packets in the main stream, and the small alphabet signs are assigned to the respective packets in the recovery stream such that the packets corresponding to each other between the main stream and the recovery stream are indicated by the same alphabet.

The third row indicates the timings of reproduction, and the packets used in the reproduction are indicated by their alphabet signs.

In the present embodiment, for the purpose of facilitating the description, it will be assumed that the first packet of each ten-packet group includes data of a reference frame, and the second to tenth packets include data of differential frames. For example, packets including data of reference frames are “A”, “K”, “U”, “a”, and “k”, and packets including data of differential frames are “B” to “J”, “L” to “T”, “V” and subsequent packets, “b” to “j”, and “1” and subsequent packets. It is noted that the intervals between reference frames are actually about 5 seconds at the longest.

In addition, in FIG. 6, an operation example in the case where the eighth packet “H” in the main stream has failed to be received is shown.

The time period from the start of transmission of the main stream to the start of transmission of the recovery stream needs to be set such that even when in the main stream, the tenth packet “J” which is a packet just before a packet that includes data of a reference frame has failed to be received, the packet “a” which is needed for using the packet “j” in the recovery stream corresponding to the packet “J” can be received.

In addition, the time period from the start of transmission of the main stream to reproduction needs to be set such that when a packet in the main stream has failed to be received, the packet in the recovery stream corresponding to the packet that has failed to be received can be received.

Here, the packets in the main stream from the packet (here, “H”) that has failed to be received to the packet (here, “J”) just before the packet that includes data of the next reference fame with respect to the frame of the packet that has failed to be received, are replaced with the corresponding packets for alternative display (here, “h” to “j”). From the packet (here, “K”) just after the replaced packets, the packets in the main stream are used again. During a period from when the reception of the main stream has failed until the reception timing of the packet “J”, supply of power to the main packet reception section 201 which relates to processing of receiving the main stream is stopped, so that the processing of receiving the main stream is not performed. The supply of power is restarted from the packet “K”, whereby the reproduction returns to normal reproduction. On the other hand, before the reception of the main stream has failed, power is not supplied to the recovery packet reception section 205 which relates to processing of receiving the recovery stream. Then, after the reception of the main stream has failed, the supply of power and the reception of the recovery stream are started from the reference frame “a” needed for reproducing the packet “h” in the recovery stream corresponding to the packet “H” in the main stream which has failed to be received. Then, when the packet “j” in the recovery stream corresponding to the packet “J” has been received, the supply of power is stopped.

When supply of power to the main packet reception section 201 is stopped, supply of power to the constituent sections, such as the main decoding section 203, that relate to the processing performed after the reception of the main stream, may be sequentially stopped in the order they completed processing of previously received data. Similarly, when supply of power to the recovery packet reception section 205 is stopped, supply of power to the constituent sections, such as the recovery decoding section 207, that relate to the processing performed after the reception of the recovery stream may be sequentially stopped in the order they completed processing of previously received data.

In FIG. 6, the case where the reference frames in the main stream correspond to the reference frames in the recovery stream, is shown as an example. However, depending on the decoding method, it is assumed that the reference frames do not correspond to each other. Even in this case, if the intervals between the reference frames are set in a predetermined range determined by the delay time of the recovery stream, the operation is normally performed without any problems.

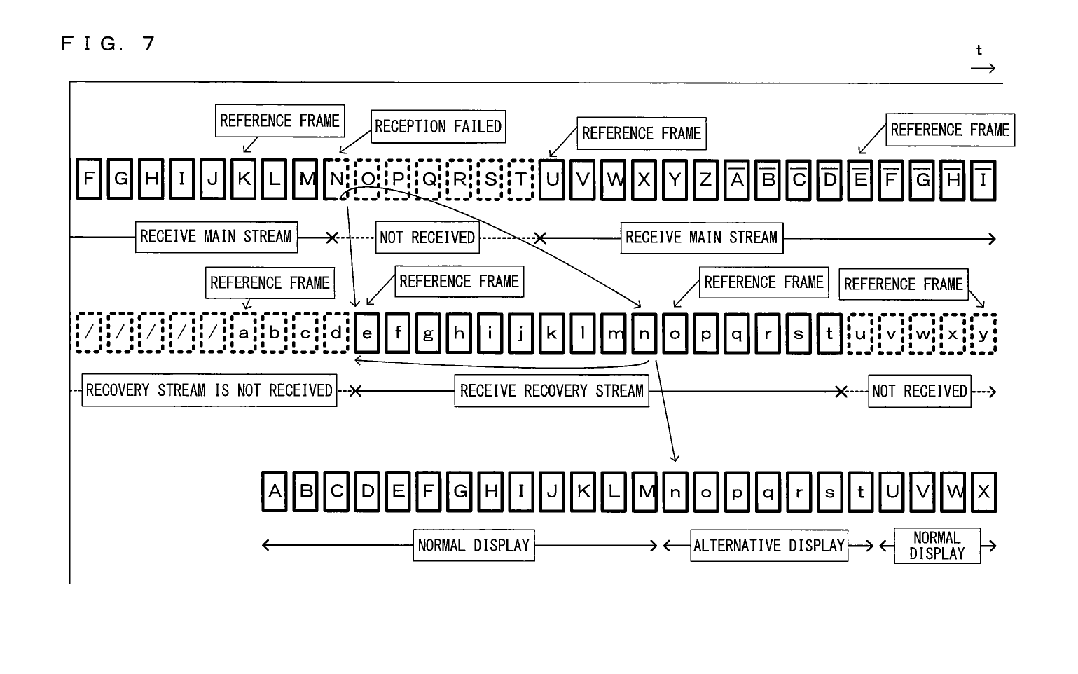

FIG. 7 is a schematic diagram showing the timings of reception, transmission, and reproduction, similarly to FIG. 6. In FIG. 7, the case where reference frames in a main stream do not correspond to reference frames in a recovery stream, is shown as an example.

The different point from FIG. 6 is the placement of the reference frames in the recovery stream. For example, packets including data of the reference frames are “A”, “K”, “U”, “a”, “e”, “o”, and “y”, and packets including data of difference frames are “B” to “J”, “L” to “T”, “V” and subsequent packets, “b” to “d”, “f” to “n”, and “p” to “x”.

In addition, in FIG. 7, an operation example in the case where the fourteenth packet “N” in the main stream has failed to be received is shown.

Here, the packets in the main stream from the packet (here, “N”) that has failed to be received to the packet (here, “T”) just before the packet that includes data of the next reference fame with respect to the frame of the packet that has failed to be received, are replaced with the corresponding packets for alternative display (here, “n” to “t”). From the packet (here, “U”) just after the replaced packets, the packets in the main stream are used again. During a period from when the reception of the main stream has failed until the reception timing of the packet “T”, supply of power to the main packet reception section 201 which relates to processing of receiving the main stream is stopped, so that the processing of receiving the main stream is not performed. The supply of power is restarted from the packet “U”, whereby the reproduction returns to normal reproduction. On the other hand, before the reception of the main stream has failed, power is not supplied to the recovery packet reception section 205 which relates to processing of receiving the recovery stream. Then, after the reception of the main stream has failed, the supply of power and the reception of the recovery stream are started from the reference frame “e” needed for reproducing the packet “n” in the recovery stream corresponding to the packet “N” in the main stream which has failed to be received. Then, when the packet “t” in the recovery stream corresponding to the packet “T” has been received, the supply of power is stopped until a packet in the main stream fails to be received again.

### <Summary of Transmission Operation>

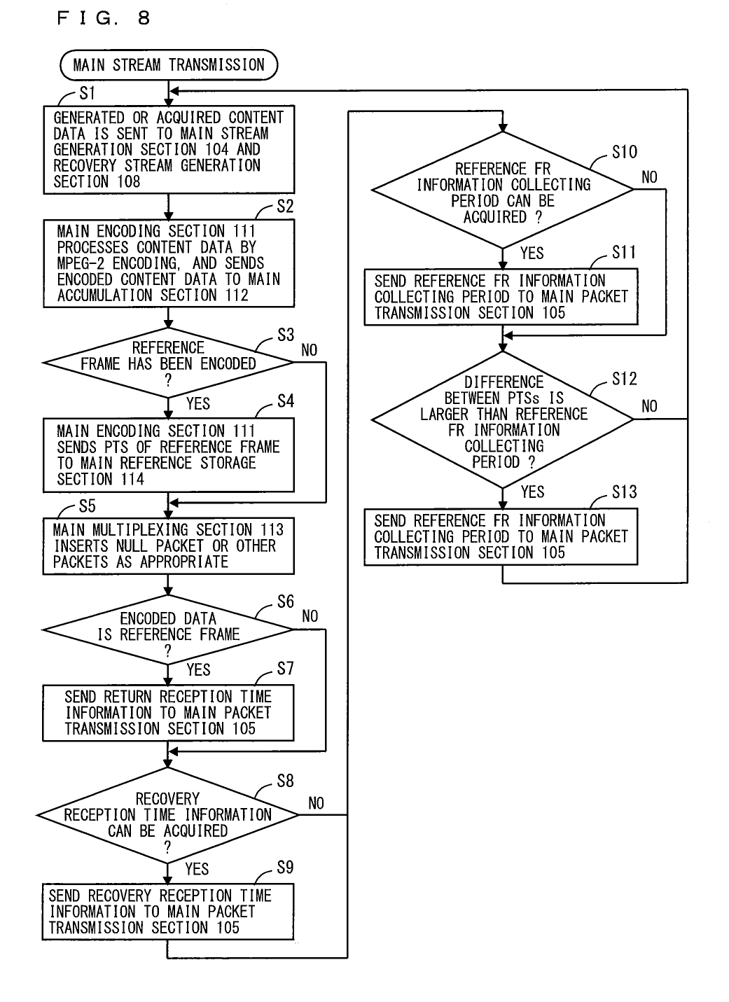

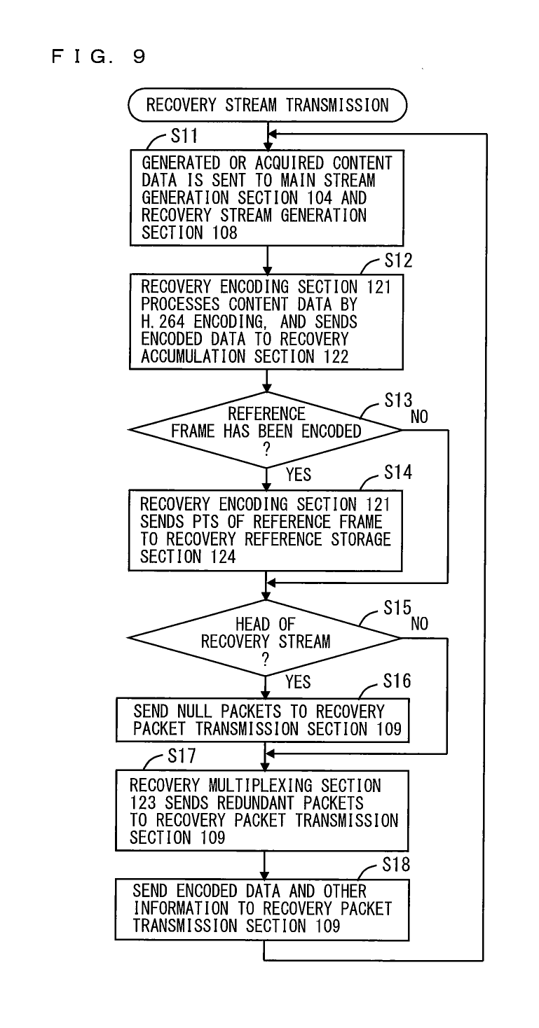

In the present embodiment, a main stream transmission operation shown in FIG. 8, and a recovery stream transmission operation shown in FIG. 9 are executed in parallel at the same time, whereby a main stream and a recovery stream are transmitted at the same time. At this time, the recovery stream is delayed relative to the main stream. In a main stream, information for, with respect to each packet, when the packet has been corrupted, specifying the time to start reception of a recovery stream, information for specifying the time to restart reception of the main stream, and the like are multiplied.

### <Main Stream Transmission Operation>

FIG. 8 shows a process of the main stream transmission operation of the main content transmitting apparatus 100.

(1) Based on an instruction from an operating person, content data generated or acquired by the content acquiring section 102 is sent to the main stream generation section 104 and the recovery stream generation section 108 (step S1).

(2) The main encoding section 111 processes the received content data by MPEG-2 encoding, and sends the encoded content data to the main accumulation section 112 which accumulates the encoded content data (step S2).

(3) Whether or not a reference frame has been encoded is determined (step S3).

(4) If a reference frame has been encoded, the main encoding section 111 sends the PTS of the reference frame to the main reference storage section 114 which stores the PTS (step S4).

The stored PTS of the reference frame is converted into the return reception time information when a return reception time information acquisition request has been issued. The return reception time information is transmitted to the content receiving apparatus 200, and is used for the main power control section 215 to control the power to the main packet reception section 201.

(5) The main multiplexing section 113 inserts a NULL packet or other packets as appropriate such that the stream is transmitted at a predetermined bit rate. Here, the encoded data and the other information are transmitted as an MPEG2-TS packet train such that the PTSs of the pieces of the encoded data are synchronized with the respective timings of transmitting the pieces of the encoded data (step S5).

Hereinafter, an example of a method for synchronizing the PTSs of the pieces of the encoded data with the timings of transmitting the pieces of the encoded data, will be described.

First, the content acquiring section 102 generates content data with 60 fps. The main encoding section 111 encodes the content data. The main accumulation section 112 stores the encoded content data.

Next, the main multiplexing section 113 multiplexes the encoded data accumulated in the main accumulation section 112, as an MPEG2-TS packet train having 48 Kbyte intervals.

The MPEG2-TS packet train is transmitted at a transmission rate of 23.04 Mbps (=48 (KByte)×8 (bit)×60 (frame)) between the content transmitting apparatus 100 and the content receiving apparatus 200.

In this way, the pieces of the encoded content data are multiplexed at appropriate positions of the MPEG2-TS packet train, in accordance with the frame rate and the transmission bit rate of the content data, whereby the PTSs of the pieces of the encoded content data can be synchronized with the actual transmission timings.

(6) Whether or not a piece of the encoded data to be transmitted is a reference frame is determined (step S6).

(7) If the piece of the encoded data is a reference frame, a return reception time information acquisition request is issued to the recovery stream generation section 108, whereby the return reception time information is acquired. Then, just before the piece of the encoded data is transmitted, the acquired return reception time information is multiplexed as a MPEG2-TS packet, and is sent to the main packet transmission section 105 (step S7).

(8) The main multiplexing section 113 determines whether or not the recovery reception time information specified by the PTS of the piece of the encoded data to be transmitted can be acquired from the recovery reference storage section 124, using the PTS as a parameter (step S8).

(9) If the recovery reception time information can be acquired, the recovery reception time information is acquired. The main multiplexing section 113 multiplexes the acquired recovery reception time information as an MPEG2-TS packet, and sends the recovery reception time information to the main packet transmission section 105 (step S9).

(10) The main packet transmission section 105 determines whether or not the reference FR information collecting period specified by the PTS of the piece of the encoded data to be transmitted can be acquired from the collecting period storage section 126, using the PTS as a parameter (step S10).

(11) If the reference FR information collecting period can be acquired, the reference FR information collecting period is acquired. The main multiplexing section 113 multiplexes the acquired reference FR information collecting period as an MPEG2-TS packet, and sends the reference FR information collecting period to the main packet transmission section 105 (step S11).

(12) Whether or not the difference between the PTSs of the oldest piece and the latest piece of the encoded data accumulated in the main accumulation section 112 is larger than the reference FR information collecting period is determined (step S12).

(13) If the difference between the PTSs is larger than the reference FR information collecting period, it is determined that more pieces of the encoded data than indicated by the reference FR information collecting period are accumulated in the main accumulation section 112. Pieces of the encoded data whose PTSs are before the time point indicated by “(the latest one of the PTSs accumulated in the main accumulation section 112)—(the reference FR information collecting period)” are sequentially acquired and sent to the main packet transmission section 105, in order starting from the oldest one (step S13).

### <Recovery Stream Transmission Operation>

FIG. 9 shows a process of the recovery stream transmission operation of the content transmitting apparatus 100.

(1) Based on an instruction from an operating person, content data generated or acquired by the content acquiring section 102 is sent to the main stream generation section 104 and the recovery stream generation section 108 (step S11).

(2) The recovery encoding section 121 processes the sent content data by H. 264 encoding, thereby generating a recovery stream, and sends the encoded data to the recovery accumulation section 122 which accumulates the encoded content data (step S12).

(3) Whether or not a reference frame has been encoded is determined (step S13).

(4) If a reference frame has been encoded, the recovery encoding section 121 sends the PTS of the reference frame to the recovery reference storage section 124 which stores the PTS (step S14).

The stored PTS of the reference frame is converted into the recovery reception time information when a recovery reception time information acquisition request has been issued. The recovery reception time information is transmitted to the content receiving apparatus 200, and is used for the recovery power control section 212 to control the power to the recovery packet reception section 201.

(5) Whether or not the encoded data is the head of the recovery stream is determined (step S15).

(6) If the encoded data is the head of the recovery stream, NULL packets the number of which is indicated by the recovery transmission delay time information stored in the recovery packet transmission delay time storage section 107 are transmitted to the recovery packet transmission section 109 (step S16).

(7) The recovery multiplexing section 123 sequentially acquires pieces of the encoded data, in the buffer of the recovery accumulation section 122, that exceed the time indicated by the value included in the collecting period storage section 126 and that can be transmitted, in chronological order starting from the oldest piece of data stored in the buffer. In addition, the recovery multiplexing section 123 inserts redundant packets among the pieces of the encoded data as appropriate, such that the recovery stream is transmitted at a predetermined transmission bit rate, and the PTSs of the pieces of the encoded data are synchronized with the respective timings of transmitting the pieces of the encoded data. The recovery multiplexing section 123 transmits the resultant data to the recovery packet transmission section 109 (step S17).

The content acquiring section 102 generates content data having a frame rate of 15 fps, the recovery encoding section 121 encodes the content data, and then the recovery accumulation section 122 accumulates the encoded data. The recovery multiplexing section 123 multiplexes the encoded data accumulated in the recovery accumulation section 122, as an H.264-TS packet train having 16 Kbyte intervals. The H.264-TS packet train is transmitted at a transmission rate of 1.92 Mbps (=16 (KByte)×8 (bit)×15 (frame)) between the content transmitting apparatus 100 and the content receiving apparatus 200. In this way, the pieces of the encoded content data are multiplexed at appropriate positions of the H. 264-TS packet train, in accordance with the frame rate and the transmission bit rate of the content data, whereby the PTSs of the pieces of the encoded content data can be synchronized with the actual transmission timings.

(8) After the redundant packets are multiplexed, the encoded data and the other information are sent, as the H. 264-TS packet train, to the recovery packet transmission section 109 (step S18).

It is noted that the content data generated or acquired in step S1 in FIG. 8 is the same as the content data generated or acquired in step S11 in FIG. 9, or otherwise, the presentation objects thereof are substantially the same so as to allow alternative display.

### <Summary of Reception Operation>

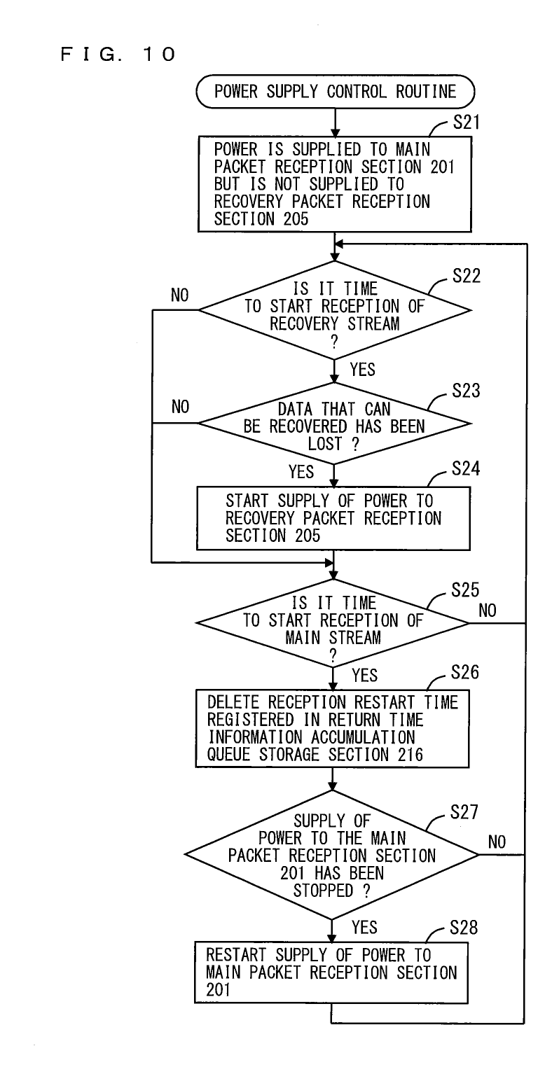

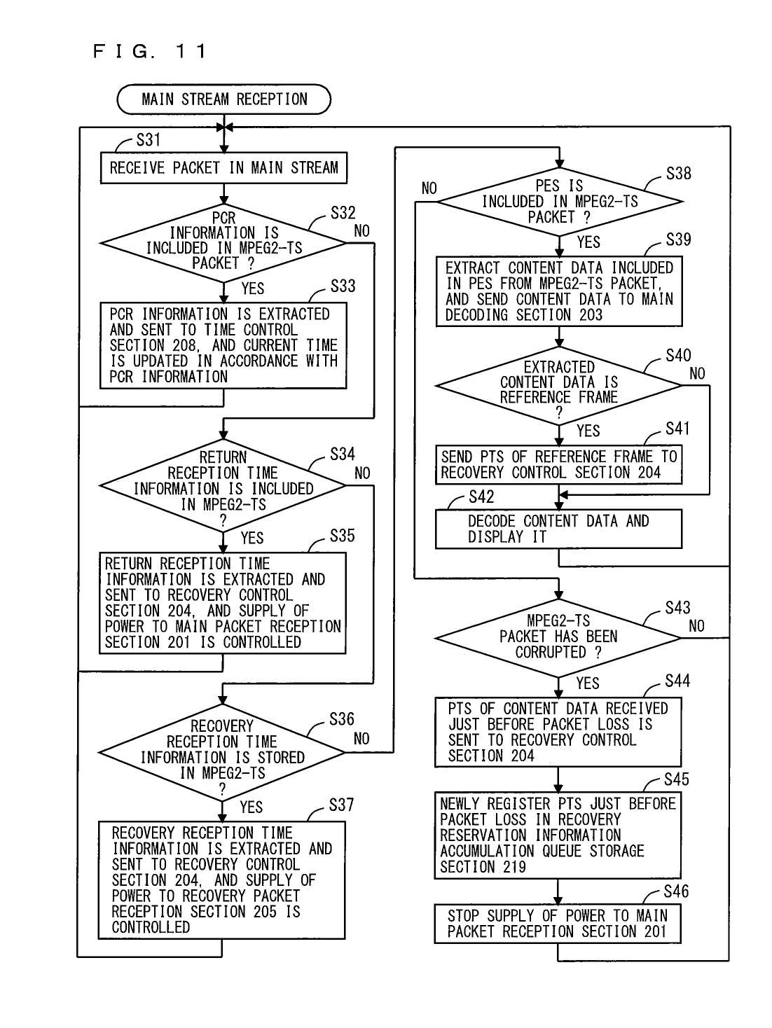

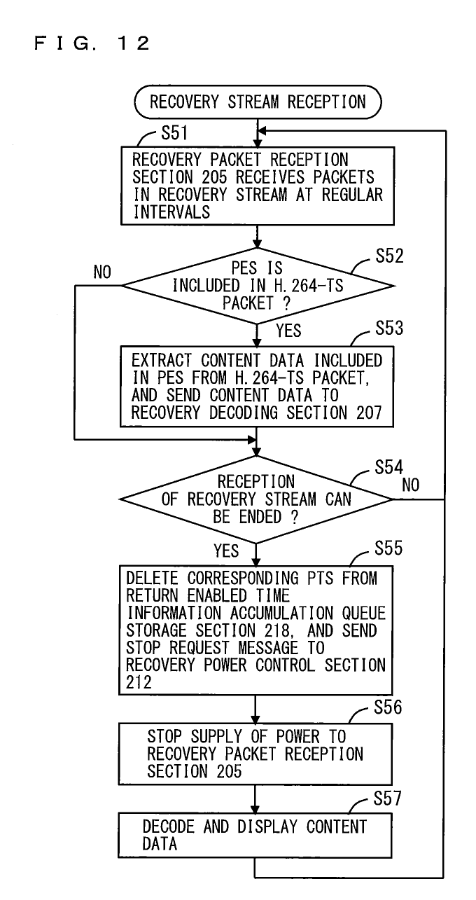

In the present embodiment, based on, for example, an instruction to reproduce a specific broadcast from a viewer, first, in a power control operation shown in FIG. 10, the main power control section 215 causes power to be supplied to the main packet reception section 201, whereby a main stream reception operation shown in FIG. 11 is started. At this time, since the recovery power control section 212 does not cause power to be supplied to the recovery packet reception section 205, a recovery stream reception operation shown in FIG. 12 is not started.

In the main stream reception operation shown in FIG. 11, in parallel with processing of reproducing and displaying a content for normal display, information for specifying the time to start reception of a recovery stream when a packet has been corrupted, information for specifying the time to restart reception of a main stream, and the like are extracted from the main stream and are stored, with respect to each packet. Then, in the main stream reception operation, if corruption of an MPEG2-TS packet has been recognized, identification information for specifying various pieces of information corresponding to the corrupted packet from previously stored information is registered, and the main power control section 215 stops supply of power to the main packet reception section 201, whereby the main stream reception operation shown in FIG. 11 is interrupted.

On the other hand, in the power supply control operation shown in FIG. 10, after an MPEG2-TS packet has been corrupted, at the time, to start reception of a recovery stream, specified based on the above identification information, the recovery power control section 212 causes power to be supplied to the main packet reception section 201, whereby a recovery stream reception operation shown in FIG. 12 is started. In addition, at the time, to restart reception of a main stream, specified based on the above identification information, the main power control section 215 causes power to be supplied to the main packet reception section 201, whereby the main stream reception operation shown in FIG. 11 is restarted.

In the recovery stream reception operation shown in FIG. 12, when the main stream reception operation has been restarted, the recovery power control section 212 stops the supply of power to the recovery packet reception section 205, whereby the recovery stream reception operation shown in FIG. 12 is stopped.

### <Power Supply Control Operation>

FIG. 10 shows a process of the power supply control operation of the content receiving apparatus 200.

(1) The main power control section 215 causes power to be supplied to the main packet reception section 201, and the recovery power control section 212 does not cause power to be supplied to the recovery packet reception section 205 (step S21).

(2) Whether or not the current time managed by the time control section 208 has reached the oldest recovery start time registered in the recovery time information accumulation queue storage section 213 is determined (step S22).

(3) If the current time has reached the oldest recovery start time, it is determined that it is time to start reception of a reference frame in a recovery stream. Then, whether or not one of the PTSs between the recovery start PTS corresponding to the recovery start time and the recovery end PTS is registered in the recovery reservation information accumulation queue storage section 219 is determined (step S23).

(4) If the above PTS is registered, it is determined that a piece of content data in a range that can be recovered has been lost in a main stream. The recovery power control section 212 starts supply of power to the recovery packet reception section 205 (step S24).

(5) Whether or not the current time managed by the time control section 208 has reached the oldest reception restart time registered in the return time information accumulation queue storage section 216 is determined (step S25).

(6) If the current time has reached the oldest reception restart time, it is determined that it is time to restart reception of a reference frame in the main stream. The oldest reception restart time registered in the return time information accumulation queue storage section 216 is deleted (step S26).

(7) Whether or not the main power control section 215 has stopped supply of power to the main packet reception section 201 is determined (step S27).

(8) If supply of power to the main packet reception section 201 has been stopped, the supply of power to the main packet reception section 201 is restarted (step S28).

Even in the case where the main power control section 215 is notified of packet loss by the recovery control section 204, if the main packet reception section 201 needs to acquire information other than content data, the main power control section 215 may continue supply of power to the main packet reception section 201 as necessary.

### <Main Stream Reception Operation>

FIG. 11 shows a process of the main stream reception operation of the content receiving apparatus 200.

(1) The main packet reception section 201 receives packets in a main stream at regular intervals. Specifically, the main packet reception section 201 receives an analog signal by using the main antenna 202, and modulates the analog signal by OFDM to generate a digital signal. Then, the main packet reception section 201 extracts an MPEG2-TS packet from the digital signal (step S31).

(2) Whether or not PCR information is included in the extracted MPEG2-TS packet is determined (step S32).

(3) If the PCR information is included, the main packet reception section 201 extracts the PCR information from the extracted PEG2-TS packet, and sends the PCR information to the time control section 208. Then, the process returns to the initial step. The time control section 208 updates the current time in accordance with the PCR information (step S33).

(4) If the PCR information is not included, a main reference FR-PID acquisition request is issued to the recovery control section 204, and the main reference FR-PID is acquired. Then, whether or not the PID of the extracted MPEG2-TS packet is equal to the acquired main reference FR-PID is determined (step S34).

(5) If the PID of the extracted MPEG2-TS packet is equal to the acquired main reference FR-PID, it is determined that return reception time information is included in the extracted MPEG2-TS packet. The main packet reception section 201 extracts the return reception time information from the PEG2-TS packet, and sends the return reception time information to the recovery control section 204. Then, the process returns to the initial step. The recovery control section 204 controls supply of power to the main packet reception section 201, based on the return reception time information (step S35).

(6) If the PID of the extracted MPEG2-TS packet is not equal to the acquired main reference FR-PID, a recovery reference FR-PID acquisition request is issued to the recovery control section 204, and the recovery reference FR-PID is acquired. Then, whether or not the PID of the extracted MPEG2-TS packet is equal to the acquired recovery reference FR-PID is determined (step S36).

(7) If the PID of the extracted MPEG2-TS packet is equal to the acquired recovery reference FR-PID, it is determined that recovery reception time information is stored in the extracted MPEG2-TS packet. The main packet reception section 201 extracts the recovery reception time information from the PEG2-TS packet, and sends the recovery reception time information to the recovery control section 204. Then, the process returns to the initial step. The recovery control section 204 controls supply of power to the recovery packet reception section 205, based on the recovery reception time information (step S37).

(8) If the PID of the extracted MPEG2-TS packet is not equal to the acquired recovery reference FR-PID, whether or not a PES (Packetized Elementary Stream) is included in the extracted MPEG2-TS packet is determined (step S38).

(9) If a PES is included in the extracted MPEG2-TS packet, the main packet reception section 201 extracts content data included in the PES from the MPEG2-TS packet, and sends the content data to the main decoding section 203 (step S39).

(10) Whether or not the extracted content data is a reference frame is determined (step S40).

(11) If the extracted content data is a reference frame, the PTS of the reference frame is sent to the recovery control section 204 (step S41).

(12) The main decoding section 203 decodes the received content data, and generates a picture frame for normal display. The picture frame is accumulated in the output waiting buffer 209 once, and then the display control section 210 causes the display section 400 to display a content. Then, the process returns to the initial step (step S42).

(13) If a PES is not included in the extracted MPEG2-TS packet (NO in step S38), whether or not the extracted MPEG2-TS packet has been corrupted is determined (step S43).

(14) If the extracted MPEG2-TS packet has been corrupted, the main packet reception section 201 sends, as packet loss position information, the PTS of a piece of content data received just before the corrupted MPEG2-TS packet was received, to the recovery control section 204 (step S44).

(15) After the recovery control section 204 has received the packet loss position information, the recovery control section 204 notifies the recovery power control section 212 of the occurrence of packet loss, using the PTS which is the packet loss position information, as a parameter. The recovery power control section 212 newly registers the PTS which is the packet loss position information and has been received as a parameter, in the recovery reservation information accumulation queue storage section 219. The PTS registered in the recovery reservation information accumulation queue storage section 219 is used for the recovery power control section 212 to control supply of power to the recovery packet reception section 205 (step S45).

(16) The main power control section 215 stops supply of power to the main packet reception section 201 (step S46).

### <Recovery Stream Reception Operation>

FIG. 12 shows a process of the recovery stream reception operation of the content receiving apparatus 200.

(1) After supply of power is started, the recovery packet reception section 205 receives packets in a recovery stream at regular intervals. Specifically, the recovery packet reception section 205 receives an analog signal by using the recovery antenna 206, and modulates the analog signal by OFDM to generate a digital signal. Then, the recovery packet reception section 205 extracts an H. 264-TS packet from the digital signal (step S51).

(2) Whether or not a PES is included in the H. 264-TS packet is determined (step S52).

(3) If a PES is included, the recovery packet reception section 205 extracts content data included in the PES from the H. 264-TS packet, and sends the content data to the recovery decoding section 207 (step S53).

(4) Whether or not the PTS of the extracted content data is registered in the return enabled time information accumulation queue storage section 218 is determined (step S54).

(5) If the PTS is registered, it is determined that the reception of the recovery stream can be ended because the recovery stream does not need to be received any longer. The PTS is deleted from the return enabled time information accumulation queue storage section 218, and a stop request message is sent to the recovery power control section 212 (step S55).

(6) After the recovery power control section 212 receives the stop request message, the recovery power control section 212 stops supply of power to the recovery packet reception section 205 (step S56).

(7) The recovery decoding section 207 decodes the received content data, to generate content data for normal display, and the display control section 210 causes the display section 400 to display a content (step S57).

### <Operations and Effects>

In the transmission apparatus and reception apparatus according to the present embodiment, even if packet loss has occurred and reception of content data has failed during reception of a main stream, content data for alternative display can be acquired from a recovery stream which is transmitted being intentionally delayed, and a series of videos can be continuously outputted. Therefore, even if the reception conditions for a plurality of streams are deteriorated at the same time, it is possible to switch the video to the content data for alternative display.

In addition, when a main stream is successfully being received, only the main stream is received, and only when the reception of the main stream has failed, a recovery stream is received, and content data for alternative display is acquired. After the reception of the main stream has failed, the reception of the main stream is stopped until the reception of the main stream becomes able to be restarted. Therefore, the operating period of reception sections can be reduced as much as possible.

Through the above operation, the effect that the operating periods of two tuners are reduced as much as possible and thus the power consumption is reduced, is provided.

In addition, in the above configuration, the image quality of a recovery stream is decreased, and the bit rate thereof is decreased. Thus, when the reception condition is normal, a high definition video with a high bit rate such as MPEG2 can be viewed, and even if the reception condition is deteriorated, a video such as H. 264 having a relatively reduced image quality, which includes increased redundant signal components and has a low bit rate and a high packet loss tolerance, can be successively viewed. In addition, a video based on a main stream and a video based on a recovery stream can be seamlessly switched to each other.

### INDUSTRIAL APPLICABILITY

The content transmitting apparatus and the content receiving apparatus of the present invention are applicable to any communication apparatuses, and have an increased packet loss tolerance and a reduced power consumption. Therefore, for example, the content transmitting apparatus and the content receiving apparatus are useful for video communication means used among home electrical apparatuses such as a monitoring camera and a mobile phone. In addition, the content transmitting apparatus can be also used as a relay apparatus for television broadcasting such as digital terrestrial broadcasting. Even if the content receiving apparatus is placed at the place where a radio wave of television broadcasting hardly arrives, the video is rarely interrupted, so that an excellent reception condition can be realized. In addition, since the power consumption can be reduced, the life of battery of a mobile phone can be increased, and the apparatus weight can be reduced.

### DESCRIPTION OF THE REFERENCE CHARACTERS

100 content transmitting apparatus

101 time control section

102 content acquiring section

103 output waiting time storage section

104 main stream generation section

105 main packet transmission section

106 main transmission antenna

107 recovery packet transmission delay time storage section

108 recovery stream generation section

109 recovery packet transmission section

110 recovery transmission antenna

111 main encoding section

112 main accumulation section

113 main multiplexing section

114 main reference storage section

121 recovery encoding section

122 recovery accumulation section

123 recovery multiplexing section

124 recovery reference storage section

125 PID storage section

126 collecting period storage section

200 content receiving apparatus

201 main packet reception section

202 main antenna

203 main decoding section

204 recovery control section

205 recovery packet reception section

206 recovery antenna

207 recovery decoding section

208 time control section

209 output waiting buffer

210 display control section

211 recovery overhead storage section

212 recovery power control section

213 recovery time information accumulation queue storage section

214 main overhead storage section

215 main power control section

216 return time information accumulation queue storage section

217 PID storage section

218 return enabled time information accumulation queue storage section

219 recovery reservation information accumulation queue storage section

220 main picture temporary accumulation section

221 recovery picture temporary accumulation section

222 reproduction timing control section

300 transmission path

400 display section

1-13. (canceled)

14. A content receiving apparatus which receives a stream transmitted from a transmitting apparatus, extracts content data from the stream, and reproduces a content, the content receiving apparatus comprising:
a first reception section configured to execute processing of sequentially receiving a first stream by predetermined unit, and extract first content data from the predetermined unit of the first stream that has been received;
a recovery control section configured to determine whether or not the first stream has been normally received by the first reception section, with respect to each predetermined unit, and to, if the recovery control section has determined that the first stream has not been normally received, issue an instruction to start reception of a second stream for alternative display which is transmitted from the transmitting apparatus later than the first stream;
a second reception section configured to, when the second reception section has received the instruction from the recovery control section,
start reception of the second stream,
receive a predetermined unit of the second stream corresponding to the predetermined unit of the first stream that the recovery stream control section has determined to have not been normally received, and
extract second content data from the predetermined unit of the second stream that has been received; and
a reproduction control section configured to
if the recovery stream section has determined that the first stream has not been normally received, reproduce a content for alternative display, based on the second content data extracted from the predetermined unit of the second stream that has been received by the second reception section, and
if the recovery stream section has determined that the first stream has been normally received, reproduce a content for normal display, at the same timing as a timing to reproduce the content for alternative display, based on the first content data extracted from the predetermined unit of the first stream that has been received by the first reception section, wherein
the first stream includes reception time information for specifying time to start reception of the second stream with respect to each packet when the packet has not been normally received,
the reception time information indicates time to receive a packet for alternative display in the second stream corresponding to the packet that has not been normally received, or time to receive a packet in the second stream that is a reference for reproducing the packet for alternative display, and
the second reception section starts reception of the second stream at time specified based on the reception time information.

15. The content receiving apparatus according to claim 14, wherein
if the recovery control section has determined that the predetermined unit of the first stream has been normally received, the recovery control section does not supply power to constituent sections for executing processing of receiving the second stream, and constituent sections for executing processing of extracting the second content data.

16. The content receiving apparatus according to claim 14, wherein
if the recovery control section has determined that the predetermined unit of the first stream has not been normally received, the recovery control section does not supply power to constituent sections for executing processing of receiving the first stream, and constituent sections for executing processing of extracting the first content data, until the processing of receiving the first stream becomes able to be restarted.

17. The content receiving apparatus according to claim 14, wherein
if the recovery control section has determined that the predetermined unit of the first stream has not been normally received, and if content data of a reference image is needed in order to reproduce a content for alternative display corresponding to a content to be reproduced based on the predetermined unit of the first stream, the recovery control section starts reception of a predetermined unit of the second stream from a position that includes the content data of the reference image that are needed.

18. The content receiving apparatus according to claim 14, wherein
the second stream has a higher transmission tolerance than the first stream.

19. A content transmitting apparatus which transmits, to a content receiving apparatus, a stream that includes content data used for reproducing a content, the content transmitting apparatus comprising:
a stream generation section configured to generate a first stream that includes first content data, and a second stream for alternative display that includes second content data used for reproducing a content for alternative display whose representation object is substantially the same as that of a content for normal display to be reproduced based on the first content data; and
a transmission section configured to transmit the first stream, and transmitting the second stream later than the first stream, so that, when a predetermined unit of the first stream has not been normally received by the content receiving apparatus, even if the content receiving apparatus starts reception of the second stream after it is determined that the predetermined unit of the first stream has not been normally received, the content receiving apparatus can receive the second stream corresponding to the predetermined unit of the first stream that has not been normally received wherein
the first stream includes reception time information for specifying time to start reception of the second stream with respect to each packet when the packet has not been normally received by the content receiving apparatus, and
the reception time information indicates time to receive a packet for alternative display in the second stream corresponding to the packet that has not been normally received by the content receiving apparatus, or time to receive a packet in the second stream that is a reference for reproducing the packet for alternative display.

20. The content transmitting apparatus according to claim 19, wherein
the stream generation section includes:
a first generation section configured to generate the first stream;
a second generation section configured to generate the second stream; and
a transmission delay time storage section configured to store, in advance, transmission delay time information indicating the interval of redundant data to be transmitted before data of the second stream is transmitted,
the transmission section includes:
a first transmission section configured to transmit the first stream; and
a second transmission section configured to transmit the second stream, and
the second generation section sends, to the second transmission section, redundant data having the interval indicated by the transmission delay time information stored in the transmission delay time storage section, thereby causing the second stream to wait to be transmitted, and sends the second stream to the second transmission section after the waiting, so that the second stream is transmitted later than the first stream.

21. The content transmitting apparatus according to claim 20, wherein
the first generation section further generates return reception time information specifying a time until which reception of the first stream can be interrupted when packet loss has occurred, such that the return reception time information is associated with each packet,
the second generation section further generates the reception time information, and
the first transmission section transmits the return reception time information generated by the first generation section and the reception time information generated by the second generation section, together with the first stream.

22. The content transmitting apparatus according to claim 20, wherein
the second generation section generates the second stream having a higher transmission tolerance than that of the first stream generated by the first generation section.

23. A computer-readable content reception program executed by a content receiving apparatus which receives a stream transmitted from a transmitting apparatus, extracts content data from the stream, and reproduces a content, wherein
the first stream, and the second stream for alternative display are used,
the first stream includes reception time information for specifying time to start reception of the second stream with respect to each packet when the packet has not been normally received, and
the reception time information indicates time to receive a packet for alternative display in the second stream corresponding to the packet that has not been normally received, or time to receive a packet in the second stream that is a reference for reproducing the packet for alternative display,
the content reception program causing the content receiving apparatus to execute:
a first reception step of executing processing of sequentially receiving the first stream by predetermined unit, and extracting first content data from the predetermined unit of the first stream that has been received;
a recovery control step of determining whether or not the first stream has been normally received in the first reception step, with respect to each predetermined unit, and of, if the recovery control step has determined that the first stream has not been normally received, issuing an instruction to start reception of the second stream which is transmitted from the transmitting apparatus later than the first stream;
a second reception step of, when the instruction has been issued in the recovery control step,
starting reception of the second stream,
receiving a predetermined unit of the second stream corresponding to the predetermined unit of the first stream that the recovery stream control step has determined to have not been normally received, and
extracting second content data from the predetermined unit of the second stream that has been received;
a reproduction control step of
if the recovery stream step has determined that the first stream has not been normally received, reproducing a content for alternative display, based on the second content data extracted from the predetermined unit of the second stream that has been received in the second reception step, and
if the recovery stream step has determined that the first stream has been normally received, reproducing a content for normal display, at the same timing as a timing to reproduce the content for alternative display, based on the first content data extracted from the predetermined unit of the first stream that has been received in the first reception step; and
a reception starting step of starting reception of the second stream at time specified based on the reception time information.

24. A content transmission program executed by a content transmitting apparatus which transmits, to a content receiving apparatus, a stream that includes content data used for reproducing a content, wherein
the first stream, and the second stream for alternative display are used,
the first stream includes reception time information for specifying time to start reception of the second stream with respect to each packet when the packet has not been normally received, and
the reception time information indicates time to receive a packet for alternative display in the second stream corresponding to the packet that has not been normally received, or time to receive a packet in the second stream that is a reference for reproducing the packet for alternative display,
the content transmission program causing the content transmitting apparatus to execute:
a stream generation step of generating the first stream which includes first content data, and the second stream which includes second content data used for reproducing a content for alternative display whose representation object is substantially the same as that of a content for normal display to be reproduced based on the first content data; and
a transmission step of transmitting the first stream, and transmitting the second stream later than the first stream, so that, when a predetermined unit of the first stream has not been normally received by the content receiving apparatus, even if the content receiving apparatus starts reception of the second stream after it is determined that the predetermined unit of the first stream has not been normally received, the content receiving apparatus can receive the second stream corresponding to the predetermined unit of the first stream that has not been normally received.

25. A content receiving method in which a stream transmitted from a transmitting apparatus is received, content data is extracted from the stream, and a content is reproduced, wherein
the first stream, and the second stream for alternative display are used,
the first stream includes reception time information for specifying time to start reception of the second stream with respect to each packet when the packet has not been normally received, and
the reception time information indicates time to receive a packet for alternative display in the second stream corresponding to the packet that has not been normally received, or time to receive a packet in the second stream that is a reference for reproducing the packet for alternative display,
the content receiving method comprising:
a first reception step of executing processing of sequentially receiving the first stream by predetermined unit, and extracting first content data from the predetermined unit of the first stream that has been received;
a recovery control step of determining whether or not the first stream has been normally received in the first reception step, with respect to each predetermined unit, and of, if the recovery control step has determined that the first stream has not been normally received, issuing an instruction to start reception of the second stream which is transmitted from the transmitting apparatus later than the first stream;
a second reception step of, when the instruction has been issued in the recovery control step,
starting reception of the second stream,
receiving a predetermined unit of the second stream corresponding to the predetermined unit of the first stream that the recovery stream control step has determined to have not been normally received, and
extracting second content data from the predetermined unit of the second stream that has been received;
a reproduction control step of
if the recovery stream step has determined that the first stream has not been normally received, reproducing a content for alternative display, based on the second content data extracted from the predetermined unit of the second stream that has been received in the second reception step, and
if the recovery stream step has determined that the first stream has been normally received, reproducing a content for normal display, at the same timing as a timing to reproduce the content for alternative display, based on the first content data extracted from the predetermined unit of the first stream that has been received in the first reception step; and
a reception starting step of starting reception of the second stream at time specified based on the reception time information.

26. A content transmitting method in which a stream that includes content data used for reproducing a content is transmitted to a content receiving apparatus, wherein
the first stream, and the second stream for alternative display are used,
the first stream includes reception time information for specifying time to start reception of the second stream with respect to each packet when the packet has not been normally received, and
the reception time information indicates time to receive a packet for alternative display in the second stream corresponding to the packet that has not been normally received, or time to receive a packet in the second stream that is a reference for reproducing the packet for alternative display,
the content transmitting method comprising:
a stream generation step of generating the first stream which includes first content data, and the second stream which includes second content data used for reproducing a content for alternative display whose representation object is substantially the same as that of a content for normal display to be reproduced based on the first content data; and
a transmission step of transmitting the first stream, and transmitting the second stream later than the first stream, so that, when a predetermined unit of the first stream has not been normally received by the content receiving apparatus, even if the content receiving apparatus starts reception of the second stream after it is determined that the predetermined unit of the first stream has not been normally received, the content receiving apparatus can receive the second stream corresponding to the predetermined unit of the first stream that has not been normally received.
